(19) United States
(12) Patent Application Publication
(10) Pub. No.: US 2023/0259818 A1
(43) Pub. Date: Aug. 17, 2023

(54) LEARNING DEVICE, FEATURE CALCULATION PROGRAM GENERATION METHOD AND SIMILARITY CALCULATOR

(71) Applicant: NEC Corporation, Minato-ku, Tokyo (JP)

(72) Inventors: Takuma AMADA, Tokyo (JP); Kazuya KAKIZAKI, Tokyo (JP)

(73) Assignee: NEC Corporation, Minato-ku, Tokyo (JP)

(21) Appl. No.: 18/014,099

(22) PCT Filed: Jul. 6, 2020
(86) PCT No.: PCT/JP2020/026359

§ 371 Date: Dec. 30, 2022

(51) Int. Cl. G06N 20/00; G06F 21/32

(52) U.S. Cl. CPC G06N 20/00; G06F 21/32

(57) ABSTRACT

Calculate a plurality of feature vectors representing features of an input sample from the input sample which is multidimensional data by using a plurality of feature calculation models. Calculate similarity between an average value of the plurality of feature vectors and a representative vector corresponding to a class to which the input sample belongs among a plurality of representative vectors corresponding to a plurality of classes respectively, the representative vector having same dimensionality as each of the plurality of feature vectors. Learn parameters of the plurality of feature calculation models based on an evaluation function in which a value is larger as the similarity between the average value of the plurality of feature vectors and the representative vector corresponding to the class to which the input sample belongs is smaller.

### TECHNICAL FIELD

The present disclosure relates to a learning device, a feature calculation program generation method, a similarity calculator, a similarity calculation method, a learning program recording medium, and a similarity calculation program recording medium.

### BACKGROUND ART

In machine learning, an attack scheme called adversarial examples in which erroneous determination is caused by adding predetermined noise to input data is known. Non Patent Document 1 discloses a technology for reducing an influence of adversarial examples by determining a final output from outputs of a plurality of models.

Non Patent Document 1 discloses a technology for obtaining cosine similarity between a feature extracted for input data and a representative vector group representing each class and learning a model so that similarity to a representative vector of a class corresponding to the input data is greater than similarity to a representative vector of another class.

### RELATED ART DOCUMENTS

### Non-Patent Documents

### [Non-Patent Document 1]

Tianyu Pang, Kun Xu, Chao Du, Ning Chen, Jun Zhu: “Improving Adversarial Robustness via Promoting Ensemble Diversity” in arXiv:1901. 08846

### [Non-Patent Document 2]

Jiankang Deng, Jia Guo, Niannan Xue, Stefanos Zafeiriou: “ArcFace: Additive Angular Margin Loss for Deep Face Recognition” in arXiv: 1801.07698

### SUMMARY

### Problem to be Solved by the Invention

According to the scheme disclosed in Non Patent Document 1, robustness against adversarial examples is improved by performing regularization so that there are diverse feature vectors which are calculation results between models. Incidentally, when one feature vector is obtained using a plurality of models as in the scheme disclosed in Non Patent Document 1, an average value of a plurality of feature calculation models calculated by a plurality of models is calculated. In the scheme disclosed in Non Patent Document 1, however, calculation accuracy may deteriorate because average values of feature vectors are close. That is, in the scheme disclosed in Non Patent Document 1, a feature which is a feature of input data is not prohibited from being a close value for each type of data.

An objective of the present disclosure is to provide a learning device, a feature calculation program generation method, a similarity calculator, a similarity calculation method, a learning program recording medium, and a similarity calculation program recording medium capable of causing a feature vector to represent a feature of data while improving robustness against adversarial examples in order to solve the above-described problem.

### Means for Solving the Problem

According to a first example aspect of the present invention, a learning device includes: computation means for calculating a plurality of feature vectors representing features of an input sample from the input sample which is multidimensional data by using a plurality of feature calculation models; similarity calculation means for calculating similarity between an average value of the plurality of feature vectors and a representative vector corresponding to a class to which the input sample belongs among a plurality of representative vectors corresponding to a plurality of classes respectively, the representative vector having same dimensionality as each of the plurality of feature vectors; and learning means for learning parameters of the plurality of feature calculation models based on an evaluation function in which a value is larger as the similarity between the average value of the plurality of feature vectors and the representative vector corresponding to the class to which the input sample belongs is smaller.

According to a second example aspect of the present invention, a feature calculation program generation method includes: calculating a plurality of feature vectors representing features of an input sample from the input sample which is multidimensional data by using a plurality of feature calculation models; calculating similarity between an average value of the plurality of feature vectors and a representative vector corresponding to a class to which the input sample belongs among a plurality of representative vectors corresponding to a plurality of classes respectively, the representative vector having same dimensionality as each of the plurality of feature vectors; learning parameters of the plurality of feature calculation models based on an evaluation function in which a value is larger as the similarity between the average value of the plurality of feature vectors and the representative vector corresponding to the class to which the input sample belongs is smaller; and generating a feature calculation program by combining the plurality of learned feature calculation models with an output function of calculating an average value of a plurality of feature vectors output by the plurality of feature calculation models.

According to a third example aspect of the present invention, a similarity calculator includes: feature calculation means for calculating a plurality of features related to first data and a plurality of features related to second data using a feature calculation program generated in accordance with the feature calculation program generation method according to the forgoing aspect; and similarity calculation means for calculating similarity between the first data and the second data based on an average value of the plurality of features related to the first data and an average value of the plurality of features related to the second data.

According to a fourth example aspect of the present invention, a similarity calculation method includes: calculating a plurality of features related to first data and a plurality of features related to second data using a feature calculation program generated in accordance with the feature calculation program generation method according to the foregoing aspect; and calculating similarity between the first data and the second data based on an average value of the plurality of features related to the first data and an average value of the plurality of features related to the second data.

According to a fifth example aspect of the present invention, a learning program stored in a recording medium causes a computer to function as: computation means for calculating a plurality of feature vectors representing features of an input sample from the input sample which is multidimensional data by using a plurality of feature calculation models; similarity calculation means for calculating similarity between an average value of the plurality of feature vectors and a representative vector corresponding to a class to which the input sample belongs among a plurality of representative vectors corresponding to a plurality of classes respectively, the representative vector having same dimensionality as each of the plurality of feature vectors; and learning means for learning parameters of the plurality of feature calculation models based on an evaluation function in which a value is larger as the similarity between the average value of the plurality of feature vectors and the representative vector corresponding to the class to which the input sample belongs is smaller.

According to a sixth example aspect of the present invention a similarity calculation program stored in a recording medium causes a computer to function as: feature calculation means for calculating a plurality of features related to first data and a plurality of features related to second data using a feature calculation program generated in accordance with the feature calculation program generation method according to the foregoing aspect; and similarity calculation means for calculating similarity between the first data and the second data based on an average value of the plurality of features related to the first data and an average value of the plurality of features related to the second data.

### Effect of the Invention

According to at least one of the aspects of the present invention, it is possible to cause a feature vector to appropriately represent a feature of data while improving robustness against adversarial examples.

### BRIEF DESCRIPTION OF THE DRAWINGS

FIG. 1 is a schematic block diagram illustrating a configuration of an authentication system 1 according to a first example embodiment.

FIG. 2 is a flowchart illustrating a learning method according to the first example embodiment.

FIG. 3 is a flowchart illustrating an authentication method by an authentication device 30 according to the first example embodiment.

FIG. 4 is a schematic block diagram illustrating a basic configuration of a learning device.

FIG. 5 is a schematic block diagram illustrating a configuration of a computer according to at least one example embodiment.

### EXAMPLE EMBODIMENT

### First Example Embodiment

### <<Configuration of Authentication System>>

Hereinafter, example embodiments will be described in detail with reference to the drawings.

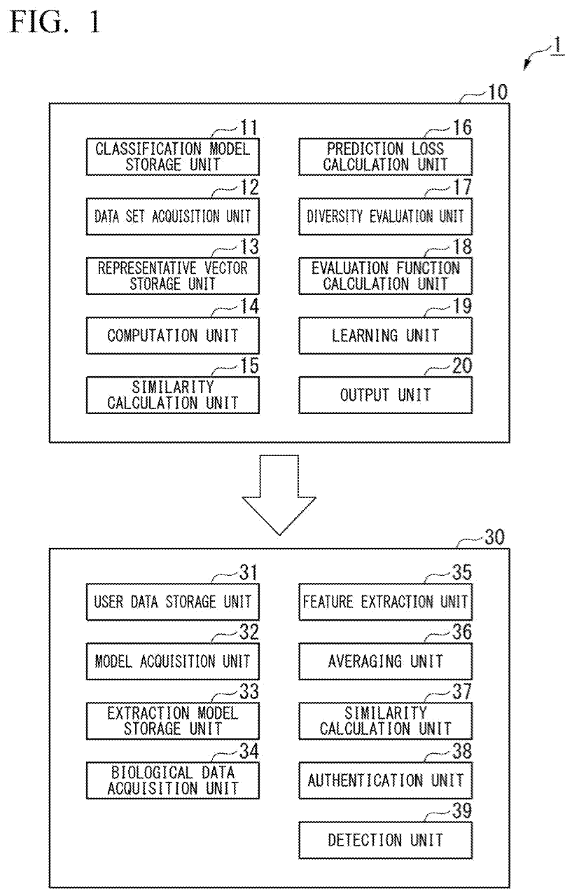

FIG. 1 is a schematic block diagram illustrating a configuration of an authentication system 1 according to a first example embodiment.

The authentication system 1 includes a learning device 10 and an authentication device 30.

The learning device 10 learns a parameter of a feature extraction model so that when biological data is input into the feature extraction model, the feature extraction model output a feature of the biological data. Examples of the biological data include a facial image, a vein image, fingerprint data, and audio data. The feature extraction model indicates a machine learning model of a neural network or the like.

The authentication device 30 performs authentication of a user based on biological data using a feature extraction model (a learned model) that has the parameter learned by the learning device 10.

The authentication system 1 according to the first example embodiment includes the learning device 10 and the authentication device 30 as separate devices, but the present disclosure is not limited thereto. For example, in the authentication system 1 according to another example embodiment, the authentication device 30 may have a function of the learning device 10.

### <<Configuration of Learning Device 10>>

The learning device 10 includes a feature extraction model storage unit 11, a data set acquisition unit 12, a representative vector storage unit 13, a computation unit 14, a similarity calculation unit 15, a prediction loss calculation unit 16, a diversity evaluation unit 17, an evaluation function calculation unit 18, a learning unit 19, and an output unit 20.

The feature extraction model storage unit 11 stores N feature extraction models formed by neural networks. Each feature extraction model accepts biological data as an input and outputs a Q-dimensional feature vector indicating a feature of the biological data. The biological data is an example of multidimensional data. The feature extraction model is formed by a neural network with two or more layers. The feature extraction model converts an input vector into a low-dimensional feature vector.

The data set acquisition unit 12 acquires a learning data set in which biological data which is an input sample is associated with a person label which is an output sample. The person label is represented by a P-dimensional one-hot vector when P is the number of people in the data set.

The representative vector storage unit 13 stores a Q-dimensional representative vector which is a vector representing a feature of a person for each person included in the learning data set. That is, dimensionality of a representative vector is the same as dimensionality of a feature vector. The representative vector may be arbitrarily set by a designer of the authentication device 30. Here, a distance between representative vectors related to other people is preferably sufficiently far. The designer may set only an initial value of the representative vector and the representative vector may be updated with learning of the feature extraction model by the learning unit 19.

The computation unit 14 calculates N feature vectors from input samples acquired by the data set acquisition unit 12 by using N feature calculation models stored in the feature extraction model storage unit 11. The computation unit calculates an average feature vector which is an average of the N feature vectors.

The similarity calculation unit 15 calculates similarity between each representative vector stored in the representative vector storage unit 13 and the average feature vector calculated by the computation unit 14. An example of the similarity is cosine similarity. The similarity calculation unit 15 generates a P-dimensional similarity vector that has similarity between each representative vector and the average feature vector as an element. That is, the similarity calculation unit 15 calculates similarity cos_{i,j} with the following Expression (1).

$$[ Math . 1 ]$$

$${cos}_{i , j} = \frac{{f}_{i} ( X , {θ}_{i} ) \cdot {W}_{j}}{\vert {f}_{i} ( X , {θ}_{i} ) \vert \vert {W}_{j} \vert} \qquad ( 1 )$$

In Expression (1), fᵢ( ) indicates an i-th feature calculation model, X indicates an input sample, θᵢ indicates a parameter of the i-th feature calculation model, and Wⱼ indicates a j-th representative vector.

The prediction loss calculation unit 16 obtains a prediction loss which is a scalar by calculating a loss function of obtaining an average value of cross entropy between an output sample and a similarity vector calculated by the similarity calculation unit 15. The prediction loss calculation unit 16 may calculate cross entropy by taking a margin m at an angle formed between a representative vector and a feature vector in an element related to the output sample among similarity vectors and multiplying all the similarity vectors by a coefficient s. The margin m and the coefficient s are hyperparameters.

The diversity evaluation unit 17 calculates a diversity evaluation value ED indicating diversity between a plurality of feature calculation models based on N feature vectors v₁ to v_{N} calculated by the computation unit 14. The diversity evaluation value ED is expressed in, for example, Expression (2).

$$[ Math . 2 ]$$

$$ED = det ( \begin{matrix}{v}_{1} \\ ⋮ \\ {v}_{N}\end{matrix} ) {( \begin{matrix}{v}_{1} \\ ⋮ \\ {v}_{N}\end{matrix} )}^{T} \qquad ( 2 )$$

That is, for a diversity evaluation value according to the first example embodiment, the diversity evaluation value ED which is a scalar is obtained by generating an N×Q feature matrix in which the N feature vectors v₁ to vₙ are arranged and calculating a determinant of a product of the feature matrix and its transposed matrix.

The evaluation function calculation unit 18 calculates an evaluation function based on a prediction loss ECE calculated by the prediction loss calculation unit 16 and the diversity evaluation value ED calculated by the diversity evaluation unit 17. An evaluation function Loss is expressed in, for example, Expression (3). In Expression (3), a is a hyperparameter.

[Math. 3]

Loss=ECE−αlog(ED) (3)

The learning unit 19 learns parameters of the plurality of feature calculation models stored in the feature extraction model storage unit 11 so that the evaluation function calculated by the evaluation function calculation unit 18 decreases.

The output unit 20 outputs the plurality of learned feature calculation models stored in the feature extraction model storage unit 11 to the authentication device 30.

### <<Learning Method>>

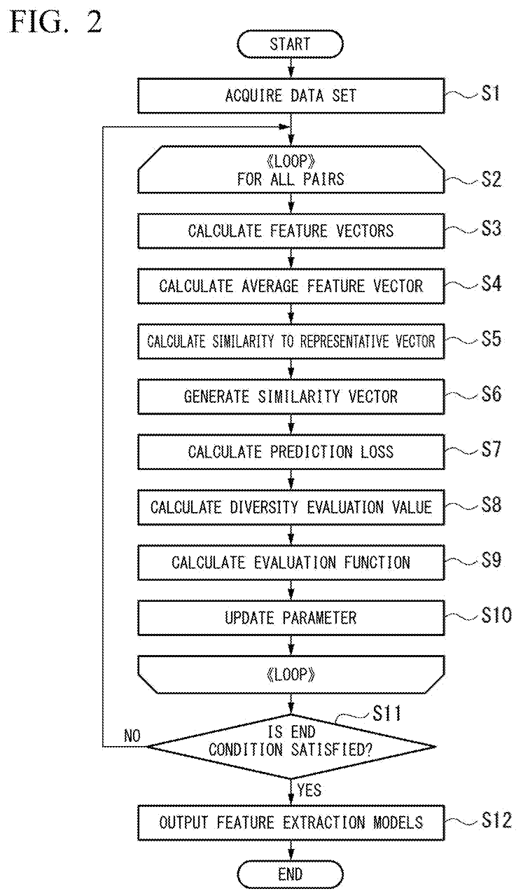

FIG. 2 is a flowchart illustrating a learning method according to the first example embodiment.

When a learning process starts, the data set acquisition unit 12 of the learning device 10 acquires a data set prepared in advance from a database (not illustrated) (step S1). The learning device 10 selects a pair of an input sample and an output sample included in the acquired data set one by one (step S2) and executes processes of the following steps S3 to S10 on all the pairs.

The computation unit 14 calculates N feature vectors by inputting the input samples related to the pairs selected in step S2 to the N feature extraction models stored in the feature extraction model storage unit 11 (step S3). The computation unit 14 calculates an average vector formed from an average value of each element of the N feature vectors (step S4).

The similarity calculation unit 15 calculates similarity between the average vector calculated in step S4 and P representative vectors corresponding to P people stored in the representative vector storage unit 13 (step S5). The similarity calculation unit 15 generates a p-dimensional similarity vector that has the calculated similarity as an element (step S6). Ideally, among the elements of the similarity vector, a value of the element corresponding to a person indicated by an input sample is close to 1, and a value of the other elements are close to 0.

The prediction loss calculation unit 16 calculates a prediction loss based on an error between the similarity vector calculated in step S6 and the one-hot vector of the output sample related to the pair selected in step S2 (step S7).

The diversity evaluation unit 17 calculates a diversity evaluation value indicating diversity between the plurality of feature calculation models based on the N feature vectors calculated in step S3 (step S8).

The evaluation function calculation unit 18 calculates an evaluation function based on the prediction loss calculated in step S7 and the diversity evaluation value calculated in step S8 (step S9). The learning unit 19 updates the parameters of the N feature extraction models stored in the feature extraction model storage unit 11 based on the evaluation function calculated in step S9 (step S10). The learning unit 19 updates each parameter in accordance with, for example, a gradient descent.

When the learning device 10 performs the processes of steps S3 to S10 on all the pairs of input samples and output samples included in the data set, the learning unit 19 determines whether an end condition of the learning is satisfied (step S11). Examples of the end condition include a condition that the number of repetitions exceeds a set number of epochs and a condition that a change amount of the evaluation function is less than a threshold.

When the end condition is not satisfied (NO in step S11), the learning device 10 returns the process to step S2 and repeats the learning process. Conversely, when the end condition is satisfied (YES in step S11), the output unit 20 outputs the N feature extraction models stored in the feature extraction model storage unit 11 to the authentication device 30 (step S12). The output unit 20 may output the feature extraction models through communication and may output the feature extraction models via a removable medium, for example.

### <<Configuration of Authentication Device 30>>

The authentication device 30 includes a user data storage unit 31, a model acquisition unit 32, an extraction model storage unit 33, a biological data acquisition unit 34, a feature extraction unit 35, an averaging unit 36, a similarity calculation unit 37, an authentication unit 38, and a detection unit 39.

The user data storage unit 31 stores account data of a user and biological data of the user in association.

The model acquisition unit 32 acquires the N learned feature extraction models from the learning device 10.

The extraction model storage unit 33 stores the N learned feature extraction models acquired by the model acquisition unit 32.

The biological data acquisition unit 34 acquires the biological data which is an authentication target from a sensor or the like provided in the authentication device 30.

The feature extraction unit 35 extracts the N feature vectors from the biological data stored in the user data storage unit 31 and the biological data acquired by the biological data acquisition unit 34 by using the N feature extraction models stored in the extraction model storage unit 33.

The averaging unit 36 calculates an average feature vector which is an average of the N feature vectors extracted by the feature extraction unit 35. The averaging unit 36 is an example of an output function of calculating an average value of the N feature vectors.

The similarity calculation unit 37 calculates similarity between two average feature vectors. Examples of a measure of the similarity include an L2 distance, cosine similarity, and probabilistic linear discriminant analysis (PLDA).

The authentication unit 38 performs authentication to determine whether a user is a user stored in the user data storage unit 31 based on the similarity calculated by the similarity calculation unit 37. The authentication unit 38 returns account data of the user when it is determined that the user is the user stored in the user data storage unit 31.

Based on the similarity calculated by the similarity calculation unit 37, the detection unit 39 determines whether the biological data acquired by the biological data acquisition unit 34 or the biological data stored in the user data storage unit 31 is an adversarial example.

For a program implementing the authentication device 30, portions configuring the extraction model storage unit 33, the feature extraction unit 35, and the averaging unit 36 may be a feature calculation program.

### <<Authentication Method>>

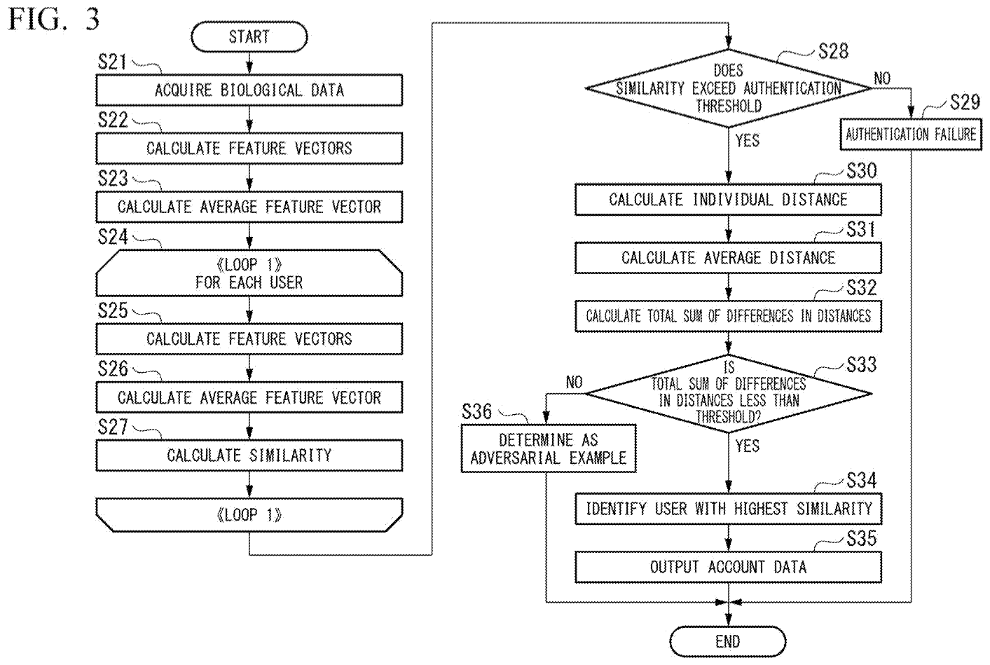

FIG. 3 is a flowchart illustrating an authentication method by the authentication device 30 according to the first example embodiment. The model acquisition unit 32 acquires a learned feature extraction model from the learning device 10 and records the learned feature extraction model in the extraction model storage unit 33 before an authentication method is performed. That is, the model acquisition unit 32 generates a feature calculation program by combining the N learned feature calculation models and an output function of calculating an average value of the N feature vectors output by the N feature calculation models.

The biological data acquisition unit 34 of the authentication device 30 acquires biological data from a sensor or the like connected to the authentication device 30 (step S21). The feature extraction unit 35 calculates the N feature vectors by inputting the biological data acquired in step S21 to the feature extraction models stored in the extraction model storage unit 33 (step S22). The averaging unit 36 generates one average feature vector from the N feature vectors (step S23). Subsequently, the authentication device 30 selects users stored in the user data storage unit 31 one by one (step S24) and performs steps S25 to S27 to be described below.

First, the feature extraction unit 35 calculates N feature vectors by inputting the biological data associated with the user selected in step S24 to the N feature extraction models stored in the extraction model storage unit 33 (step S25). The averaging unit 36 generates one average feature vector from the N feature vectors (step S26). Subsequently, the similarity calculation unit 37 calculates similarity between the average feature vector calculated in step S23 and the average feature vector calculated in step S26 (step S27).

When the similarity to the acquired biological data is calculated for each user stored in the user data storage unit 31, the authentication unit 38 determines whether the similarity exceeds a predetermined authentication threshold among the calculated similarities (step S28). When all the similarities are equal to or less than the authentication threshold (NO in step S28), the authentication unit 38 determines that authentication of the biological data acquired in step S21 fails (step S29) and the process ends.

Conversely, when at least one similarity exceeds the authentication threshold (YES in step S28), the detection unit 39 calculates an individual distance which is an L2 norm distance corresponding to the N feature extraction models based on the N feature vectors calculated in step S22 and the N feature vectors calculated in step S25 (step S30). The detection unit 39 calculates an average distance which is an L2 norm distance between the average feature vector calculated in step S23 and the average feature vector calculated in step S26 (step S31). The detection unit 39 calculates a total sum of differences between each of the N individual distances and the average distance (step S32). The detection unit 39 determines whether the total sum of the differences in the distances calculated in step S32 is less than a predetermined threshold (step S33).

When the total sum of the differences in the distances is less than the predetermined threshold (YES in step S33), the authentication unit 38 identifies a user related to the highest similarity in step S28 (step S34) and outputs the account data of the user (step S35).

Conversely, when the total sum of the differences in the distances is equal to or greater than the predetermined threshold (NO in step S33), the detection unit 39 determines that the biological data acquired in step S21 or the biological data related to the highest similarity in step S28 is an adversarial example (step S36).

### Operational Effects

In this way, according to the first example embodiment, the learning device 10 calculates the similarity between the plurality of representative vectors, which have same dimensionality as the feature vectors, and the average value of the plurality of feature vectors and learns parameters of the plurality of feature calculation models based on the evaluation function in which the similarity is used. By learning the parameters of the plurality of feature calculation models so that the similarity between the representative vector and the average feature vector increases, it is possible to have a distance at which the average feature vectors belonging to different classes are constant, and thus it is possible to improve calculation accuracy.

The learning device 10 according to the first example embodiment calculates the similarity between each of the plurality of representative vectors and the average value of the plurality of feature vectors and learns the parameters of the plurality of feature calculation models based on the evaluation function in which a value is larger as an error between a similarity vector that has the similarity as an element and a one-hot vector representing a class to which an input sample belongs is larger. However, the present disclosure is not limited thereto. For example, in the learning device 10 according to another example embodiment, the similarity between the representative vector corresponding to the class to which the input sample belongs and an average feature vector is included in a term of the evaluation function.

The learning device 10 according to the first example embodiment learns the parameters of the plurality of feature calculation models using the evaluation function in which a value is larger as a diversity index value related to a height of diversity of the plurality of feature vectors is smaller. Thus, a distance between the feature vectors calculated by the plurality of feature calculation models is larger, and thus it is possible to improve robustness against an adversarial example.

The learning device 10 according to another example embodiment may learn parameters of the plurality of feature calculation models using an evaluation function which is based on a total sum of distances from the feature vectors of the feature calculation models instead of the diversity index value.

### Other Example Embodiments

The above-described example embodiment has been described in detail above with reference to the drawings, but specific configurations are not limited to the above-described configurations and various changes in design or the like can be made. That is, in other example embodiments, a procedure of the above-described processes may be changed as appropriate. Some of the processes may be performed in parallel.

The learning device 10 according to the above-described example embodiment may be configured by a single computer. The configuration of the learning device 10 may be separately disposed in a plurality of computers and the plurality of computers may cooperate with each other to function as the learning device 10. The learning device 10 and the authentication device 30 may be implemented by the same computer.

The learning device 10 according to the above-described example embodiment obtains the average similarity by obtaining the average feature vector and then calculating the similarity between the average feature vector and the representative vector. In another example embodiment, however, the present disclosure is not limited thereto. For example, in the other example embodiment, the learning device 10 may obtain the average similarity by obtaining similarity between an individual feature vector and the representative vector and calculating the average.

### <Basic Configuration>

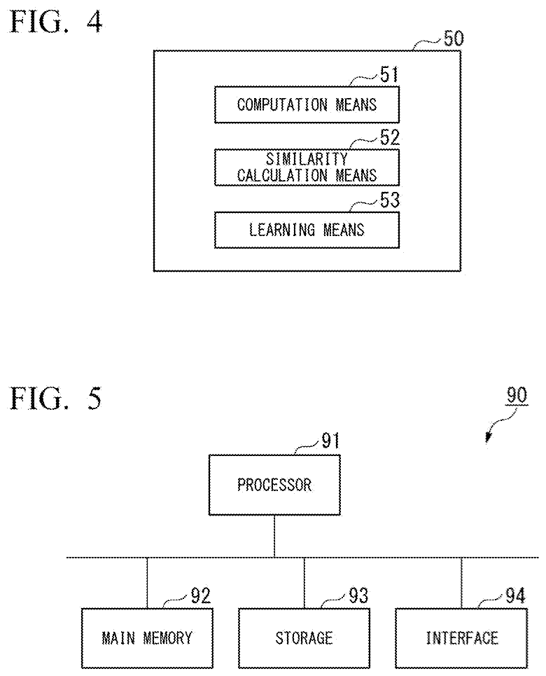

FIG. 4 is a schematic block diagram illustrating a basic configuration of the learning device.

In the above-described example embodiment, the configuration illustrated in FIG. 1 has been described as an example embodiment of the learning device, but a basic configuration of the learning device is illustrated in FIG. 4.

That is, the learning device 50 includes computation means 51, similarity calculation means 52, and learning means 53 as a basic configuration.

The computation means 51 calculates a plurality of feature vectors representing features of an input sample from the input sample which is multidimensional data by using a plurality of feature calculation models.

The similarity calculation means 52 calculates similarity between an average value of the plurality of feature vectors and a representative vector corresponding to a class to which the input sample belongs among a plurality of representative vectors, which have same dimensionality as the feature vectors, corresponding to a plurality of classes respectively.

The learning means learns parameters of the plurality of feature calculation models based on an evaluation function in which a value is larger as the similarity between the average value of the plurality of feature vectors and the representative vector corresponding to the class to which the input sample belongs is smaller.

Accordingly, in the learning device 50, due to the plurality of feature vectors, the feature vector can appropriately indicate a feature of data while improving robustness against an adversarial example.

### <Computer Configuration>

FIG. 5 is a schematic block diagram illustrating a configuration of a computer according to at least one example embodiment.

A computer 90 includes a processor 91, a main memory 92, a storage 93, and an interface 94.

The above-described learning device 10 and authentication device 30 are mounted on the computer 90. An operation of each of the above-described processing units is stored in a form of a program in the storage 93. The processor 91 reads a program (a learning program or a similarity calculation program) from the storage 93, loads the program on the main memory 92, and executes the process in accordance with the program. The processor 91 guarantees a storage region corresponding to the above-described storage unit in the main memory 92 in accordance with the program. Examples of the processor 91 include a central processing unit (CPU), a graphic processing unit (GPU), and a microprocessor.

The program may implement some of functions realized by the computer 90. For example, the program may be combined with another program stored in advance in the storage or may be combined with another program loaded on another device to realize a function. According to another example embodiment, the computer 90 may include a custom large scale integrated circuit (LSI) such as a programmable logic device (PLD) in addition or instead of the foregoing configuration. Examples of the PLD include a programmable array logic (PAL), a generic array logic (GAL), a complex programmable logic device (CPLD), and a field programmable gate array (FPGA). In this case, some or all of the functions implemented by the processor 91 may be implemented by the integrated circuit. The integrated circuit is included in the examples of the processor.

Examples of the storage 93 include a magnetic disk, a magneto-optical disc, an optical disc, and a semiconductor memory. The storage 93 may be an internal medium directly connected to a bus of the computer 90 or may be an external medium connected to the computer 90 via the interface 94 or a communication line. When the program is delivered to the computer 90 via the communication line, the computer 90 to which the program is delivered may load the program on the main memory 92 and execute the process. In at least one example embodiment, the storage 93 is a non-transitory storage medium.

The program may implement some of the above-described functions. Further, the program may be a so-called file (a difference program) that implements the above-described functions in combination with another program stored in advance in the storage 93.

### REFERENCE SIGNS LIST

1 Authentication system
Learning device
11 Feature extraction model storage unit
12 Data set acquisition unit
13 Representative vector storage unit
14 Computation unit
Similarity calculation unit
16 Prediction loss calculation unit
17 Diversity evaluation unit
18 Evaluation function calculation unit
19 Learning unit
20 Output unit
30 Authentication device
31 User data storage unit
32 Model acquisition unit
33 Extraction model storage unit
34 Biological data acquisition unit
35 Feature extraction unit
36 Averaging unit
37 Similarity calculation unit
38 Authentication unit
39 Detection unit

What is claimed is:

1. A learning device comprising:
at least one memory configured to store instructions; and
at least one processor configured to execute the instructions to:
calculate a plurality of feature vectors representing features of an input sample from the input sample which is multidimensional data by using a plurality of feature calculation models;
calculate similarity between an average value of the plurality of feature vectors and a representative vector corresponding to a class to which the input sample belongs among a plurality of representative vectors to corresponding to a plurality of classes respectively, the representative vector having same dimensionality as each of the plurality of feature vectors; and
learn parameters of the plurality of feature calculation models based on an evaluation function in which a value is larger as the similarity between the average value of the plurality of feature vectors and the representative vector corresponding to the class to which the input sample belongs is smaller.

2. The learning device according to claim 1,
wherein the at least one processor is further configured to execute the instructions to:
calculate average similarity between each of the plurality of representative vectors and the plurality of feature vectors, and
wherein, in the evaluation function, the value is larger as an error between a similarity vector that has the average similarity for each class as an element and a one-hot vector indicating a class to which the input sample belongs.

3. The learning device according to claim 1, wherein the at least one processor is further: configured to execute the instructions to:
calculate a diversity index value related to a height of diversity of the plurality of feature vectors,
wherein, in the evaluation function, the value is larger as the similarity between the average value of the plurality of feature vectors and the representative vector corresponding to the class to which the input sample belongs is smaller, and the value is large as the diversity index value is smaller.

4. The learning device according to claim 3, wherein the diversity index value is calculated by calculating a determinant of a product of a matrix in which a plurality of feature vectors are arranged and a transposed matrix of the matrix.

5. A feature calculation program generation method comprising:
calculating a plurality of feature vectors representing features of an input sample from the input sample which is multidimensional data by using a plurality of feature calculation models;
calculating similarity between an average value of the plurality of feature vectors and a representative vector corresponding to a class to which the input sample belongs among a plurality of representative vectors corresponding to a plurality of classes respectively, the representative vector having same dimensionality as each of the plurality of feature vectors;
learning parameters of the plurality of feature calculation models based on an evaluation function in which a value is larger as the similarity between the average value of the plurality of feature vectors and the representative vector corresponding to the class to which the input sample belongs is smaller; and
generating a feature calculation program by combining the plurality of learned feature calculation models with an output function of calculating an average value of a plurality of feature vectors output by the plurality of feature calculation models.

6. The feature calculation program generation method according to claim 5, further comprising:
calculating a diversity index value related to a height of diversity of the plurality of feature vectors,
wherein, in the evaluation function, the value is larger as the similarity between the average value of the plurality of feature vectors and the representative vector corresponding to the class to which the input sample belongs is smaller, and the value is large as the diversity index value is smaller.

7. A similarity calculator comprising:
at least one memory configured to store instructions; and
at least one processor configured to execute the instructions to:
calculate a plurality of features related to first data and a plurality of features related to second data using a feature calculation program generated in accordance with the feature calculation program generation method according to claim 5; and
calculate similarity between the first data and the second data based on an average value of the plurality of features related to the first data and an average value of the plurality of features related to the second data.

8-10. (canceled)
